(19) United States
(12) Patent Application Publication
(10) Pub. No.: US 2026/0351825 A1
(43) Pub. Date: Nov. 5, 2026

(54) MICRO-ELECTRO-MECHANICAL-SYSTEMS PHASE SHIFTERS HAVING A WAVEGUIDE CORE WITH A FERROELECTRIC LAYER INTEGRATED WITH THE WAVEGUIDE CORE

(71) Applicant: GlobalFoundries U.S. Inc., Malta, NY (US)

(72) Inventors: Raghuram Tattamangalam Raman, Bangalore (IN); Aneesh Dash, Bangalore (IN)

(21) Appl. No.: 19/198,304

(22) Filed: May 5, 2025

(51) Int. Cl. H01P 1/18; G02F 1/025

(52) U.S. Cl. CPC H01P 1/181; G02F 1/025; H01P 1/182; H01P 1/184

(57) ABSTRACT

Structures for a phase shifter and methods of forming a structure for a phase shifter. The structure comprises a waveguide core including a section, a ferroelectric layer on the section of the waveguide core, and a Micro-Electro-Mechanical Systems structure including a beam adjacent to the section of the waveguide core and the ferroelectric layer. The ferroelectric layer comprises a ferroelectric material.

### BACKGROUND

The disclosure relates to photonic chips and, more specifically, to structures for a phase shifter and methods of forming a structure for a phase shifter.

Photonic chips are used in many applications and systems including, but not limited to, data communication systems and data computation systems. A photonic chip includes a photonic integrated circuit comprised of photonic components, such as modulators, polarizers, and couplers, that are used to manipulate light received from a light source, such as an optical fiber or a laser.

A phase shifter is a photonic component that can be used on a photonic chip to modulate the phase of light propagating in a waveguide core. One type of phase shifter may operate by a thermo-optic mechanism in which heat is transferred to the waveguide core, which is comprised of a material having a refractive index that varies with temperature. Another type of phase shifter may operate by an electro-optic mechanism by biasing a p-n junction inside the waveguide core. A Micro-Electro-Mechanical Systems (MEMS) phase shifter uses micro-scale mechanical components to modulate the phase of light propagating in a waveguide core. Conventional MEMS phase shifters offer high power efficiency and low insertion loss but are characterized by high operating voltages and present challenges in controlling the dynamic range.

Improved structures for a phase shifter and methods of forming a structure for a phase shifter are needed.

### SUMMARY

In an embodiment of the invention, a structure for a phase shifter is provided. The structure comprises a waveguide core including a section, a ferroelectric layer on the section of the waveguide core, and a Micro-Electro-Mechanical Systems structure including a beam adjacent to the section of the waveguide core and the ferroelectric layer. The ferroelectric layer comprises a ferroelectric material.

In an embodiment of the invention, a method of forming a structure for a phase shifter is provided. The method comprises forming a waveguide core, forming a ferroelectric layer on a section of the waveguide core, and forming a Micro-Electro-Mechanical Systems structure including a beam adjacent to the section of the waveguide core and the ferroelectric layer. The ferroelectric layer comprises a ferroelectric material.

### BRIEF DESCRIPTION OF THE DRAWINGS

The accompanying drawings, which are incorporated in and constitute a part of this specification, illustrate various embodiments of the invention and, together with a general description of the invention given above and the detailed description of the embodiments given below, serve to explain the embodiments of the invention. In the drawings, like reference numerals refer to like features in the various views.

FIG. 1 is a top view of a structure at an initial fabrication stage of a processing method in accordance with embodiments of the invention.

FIG. 1A is a cross-sectional view taken generally along line 1A-1A in FIG. 1.

FIG. 2 is a top view of the structure at a fabrication stage of the processing method subsequent to FIGS. 1, 1A.

FIG. 2A is a cross-sectional view taken generally along line 2A-2A in FIG. 2.

FIG. 3 is a cross-sectional view of a structure in accordance with alternative embodiments of the invention.

FIG. 4 is a top view of a structure in accordance with alternative embodiments of the invention.

### DETAILED DESCRIPTION

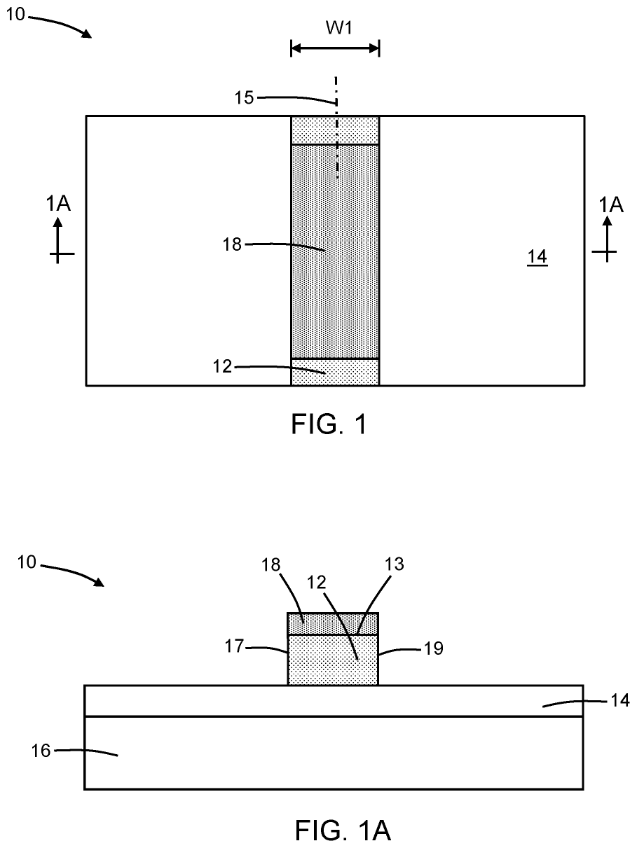

With reference to FIGS. 1, 1A and in accordance with embodiments of the invention, a structure 10 for a phase shifter includes a waveguide core 12 and a ferroelectric layer 18 that are disposed on, and overlie, a dielectric layer 14 and a semiconductor substrate 16 of a photonics chip. In an embodiment, the dielectric layer 14 may be comprised of a dielectric material, such as an oxide like silicon dioxide, and the semiconductor substrate 16 may be comprised of a semiconductor material, such as single-crystal silicon. In an embodiment, the dielectric layer 14 may be a buried oxide layer of a silicon-on-insulator substrate.

The waveguide core 12 may have a top surface 13, a sidewall 17, and a sidewall 19 opposite from the sidewall 17. The waveguide core 12 may extend lengthwise along a longitudinal axis 15. In an embodiment, the waveguide core 12 may be comprised of a material having a refractive index that is greater than the refractive index of silicon dioxide. In an embodiment, the waveguide core 12 may be comprised of a doped semiconductor material, such as silicon doped with a concentration of either an n-type or p-type dopant. In an embodiment, the waveguide core 12 may be formed by depositing a layer comprised of its constituent material and patterning the deposited layer with lithography and etching processes. In an embodiment, the waveguide core 12 may be formed by patterning a device layer of a silicon-on-insulator substrate.

The ferroelectric layer 18 overlies the top surface 13 of a section of the waveguide core 12. In an embodiment, the ferroelectric layer 18 may fully overlap with the top surface 13 of the section of the waveguide core 12. In an embodiment, the ferroelectric layer 18 may adjoin the top surface 13 of the section of the waveguide core 12. In an embodiment, the ferroelectric layer 18 may adjoin and directly contact the top surface 13 of the section of the waveguide core 12. In an embodiment, the ferroelectric layer 18 and the waveguide core 12 may have equal width dimensions W1.

The ferroelectric layer 18 may be comprised of a ferroelectric material. In an embodiment, the ferroelectric material of the ferroelectric layer 18, which may be an electrical insulator, may have a permittivity that is greater than the permittivity of the dielectric material of the waveguide core 12. The ferroelectric material constituting the ferroelectric layer 18 may be deposited by, for example, by atomic layer deposition and crystallized by an anneal following deposition. In an embodiment, the ferroelectric layer 18 may include crystalline grains characterized by an orthorhombic phase that is ferroelectric. In an embodiment, the ferroelectric material may be comprised of a hafnium-based material. In an embodiment, the ferroelectric material may be comprised of hafnium oxide. In an embodiment, the ferroelectric material may be comprised of an oxide that contains hafnium and zirconium. In an embodiment, the ferroelectric material may be comprised of hafnium zirconium oxide. In an embodiment, a thin interfacial layer comprised of silicon oxide (e.g., silicon dioxide) may be positioned between the ferroelectric layer 18 and the top surface 13 of the section of the waveguide core 12.

The grains of ferroelectric material constituting the ferroelectric layer 18 are characterized by a pair of remanent polarization states that can be reversibly varied in response to an applied voltage and that are persistent and non-volatile after the electric field associated with the applied voltage is removed. In one remnant polarization state of the grains, the net remnant polarization of the ferroelectric material may be oriented, for example, parallel to the normal to the top surface 13 of the waveguide core 12. In the other remnant polarization state of the grains, the net remnant polarization of the ferroelectric material may be oriented, for example, anti-parallel to the normal to the top surface 13 of the waveguide core 12. The net remnant polarization of the ferroelectric layer 18 is given by a sum of the individual remanent polarization states of the grains. Because of the energy barrier that separates the remanent polarization states, the ferroelectric material of the ferroelectric layer 18 may exhibit a negative capacitance state while in non-equilibrium between the net remnant polarizations. The negative capacitance state may be stabilized by, for example, using a series capacitor.

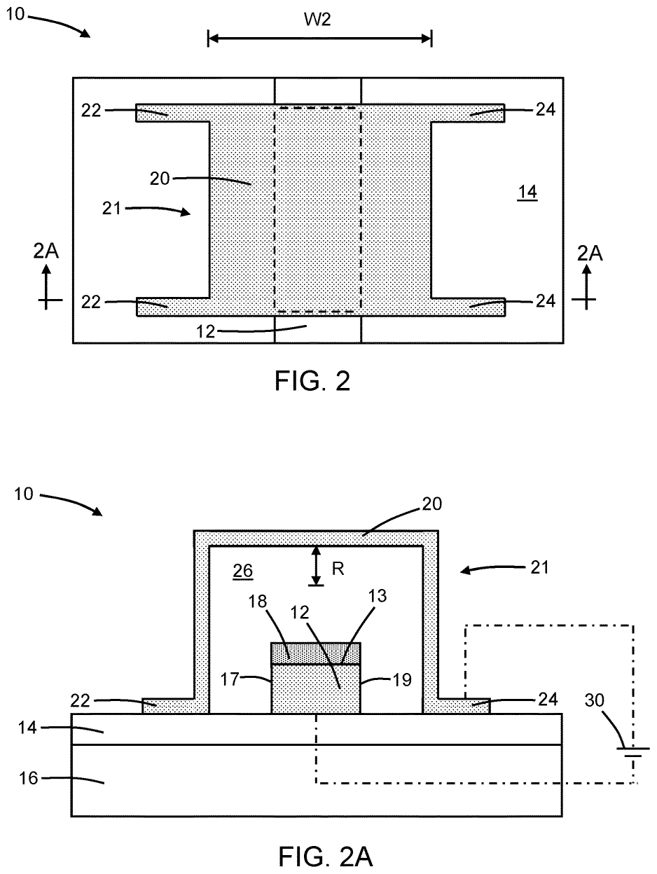

With reference to FIGS. 2, 2A in which like reference numerals refer to like features in FIGS. 1, 1A and at a subsequent fabrication stage, a beam 20 of a Micro-Electro-Mechanical Systems (MEMS) structure 21 may be formed that overlies the ferroelectric layer 18 and the section of the waveguide core 12 underlying the ferroelectric layer 18. The MEMS structure 21 includes clamping sections 22, 24 providing anchors that clamp the beam 20 at its opposite side edges. The clamping sections 22, 24 may be mechanically coupled to the dielectric layer 14 and provide static supports for movement of the beam 20. The beam 20 is laterally arranged between the clamping sections 22 and the clamping sections 24 and is suspended above the section of the waveguide core 12 and the ferroelectric layer 18 on the section of the waveguide core 12. In an embodiment, the beam 20 may have a width dimension W2 that is greater than the width dimension W1.

The ferroelectric layer 18 may be arranged in a vertical direction between the section of the waveguide core 12 and the beam 20. The waveguide core 12 and the ferroelectric layer 18 may be arranged in a vertical direction between the beam 20 and the semiconductor substrate 16. In an embodiment, the beam 20 and the clamping sections 22, 24 of the MEMS structure 21 may be comprised of a metal, such as aluminum. In an embodiment, the beam 20 and the clamping sections 22, 24 of the MEMS structure 21 may be comprised of doped polycrystalline silicon.

The beam 20 of the MEMS structure 21 is arranged adjacent to the ferroelectric layer 18 and the section of the waveguide core 12 underlying the ferroelectric layer 18. An air gap 26 may be arranged in the space between the beam 20 and the ferroelectric layer 18. In an embodiment, the air gap 26 may surround the ferroelectric layer 18 and the section of the waveguide core 12 underlying the ferroelectric layer 18. The air gap 26 may be characterized by a permittivity or dielectric constant of near unity (i.e., vacuum permittivity), which is less than the permittivity of solid dielectric material. The air gap 26 may be filled by atmospheric air at or near atmospheric pressure, may be filled by another gas at or near atmospheric pressure, or may contain atmospheric air or another gas at a sub-atmospheric pressure (e.g., a partial vacuum).

A power supply 30 may have a terminal that is connected to the MEMS structure 21 and a terminal that is connected to the waveguide core 12. The beam 20 of the MEMS structure 21 may function as an upper electrode and the waveguide core 12 may function as a lower electrode. The power supply 30 may be operated to supply an actuation voltage that causes the beam 20 to move relative to the waveguide core 12 over a travel range R while the clamping sections 22, 24 maintain stationary in static or fixed positions. In an embodiment, the power supply 30 may apply an actuation voltage that biases the beam 20 to deform over a travel range R in a direction toward the waveguide core 12. In the absence of an applied actuation voltage, the beam 20 may have an equilibrium position that is spaced from the waveguide core 12 by a larger distance than when an actuation voltage is present. In the negative capacitance state, the ferroelectric layer 18 functions to boost or enhance the actuation voltage that is applied by the power supply 30 to cause the beam 20 to deform such that the actuation voltage of the MEMS structure 21 can be reduced.

In use, the waveguide core 12 may guide propagating light along a light path parallel to the longitudinal axis 15 such that the highest optical intensity region of the optical mode is disposed within the waveguide core 12 and immediately adjacent to the top surface 13 and the sidewalls 17, 19 of the waveguide core 12. An actuation voltage applied by the power supply 30 may move the beam 20 toward the waveguide core 12 by bowing such that the effective refractive index of the section of the waveguide core 12 beneath the ferroelectric layer 18 is changed. As a result, the transmission of light may be altered in the section of the waveguide core 12 underlying the ferroelectric layer 18.

The phase shifter embodied in the structure 10 is charactered by a suspended clamped-clamped conducting beam 20 of the MEMS structure 21. The phase shifter embodied in the structure 10 has a hybrid construction due to the integration of the ferroelectric layer 18. The phase shifter embodied in the structure 10 may have a higher efficiency than conventional phase shifters because the ferroelectric layer 18 reduces the actuation voltage of the MEMS structure 21, thereby enabling the change in the effective refractive index of the associated section of the waveguide core 12 at a reduced actuation voltage. In an alternative embodiment, phase shifter embodied in the structure 10 may function as a switch configured to modulate light propagating in the waveguide core 12.

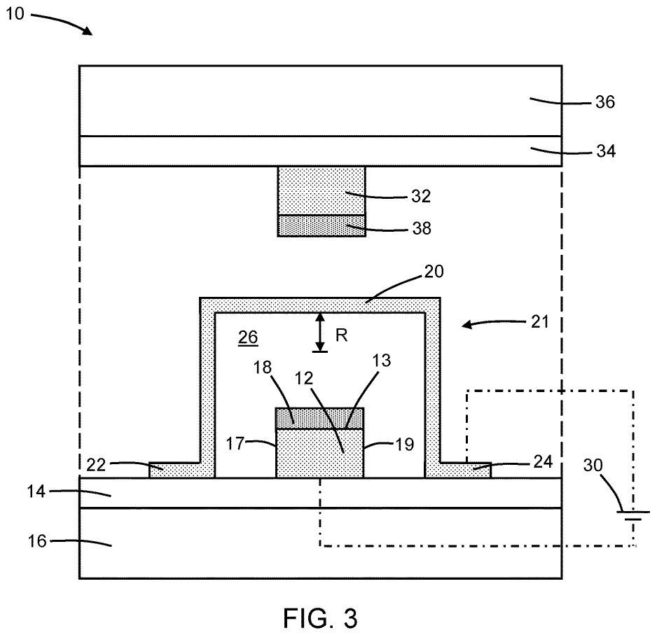

With reference to FIG. 3 and in accordance with alternative embodiments, the structure 10 may include a waveguide core 32 and a ferroelectric layer 38 that are disposed on, and overlie, a dielectric layer 34 and a semiconductor substrate 36 of a photonics chip. The photonics chip including the dielectric layer 34 and the semiconductor substrate 36 may be bonded to the photonics chip including the dielectric layer 14 and the semiconductor substrate 16 by a wafer bonding technique, such as dielectric bonding or hybrid bonding.

The ferroelectric layer 38 may be arranged on a section of the waveguide core 32 similar to the arrangement between ferroelectric layer 18 and the section of the waveguide core 12 beneath the ferroelectric layer 18. The beam 20 of the MEMS structure 21 may be arranged in a vertical direction between the section of the waveguide core 12 and the section of the waveguide core 32, as well as between the ferroelectric layer 18 and the ferroelectric layer 38. The ferroelectric layer 38 may be arranged in a vertical direction between the section of the waveguide core 32 and the beam 20.

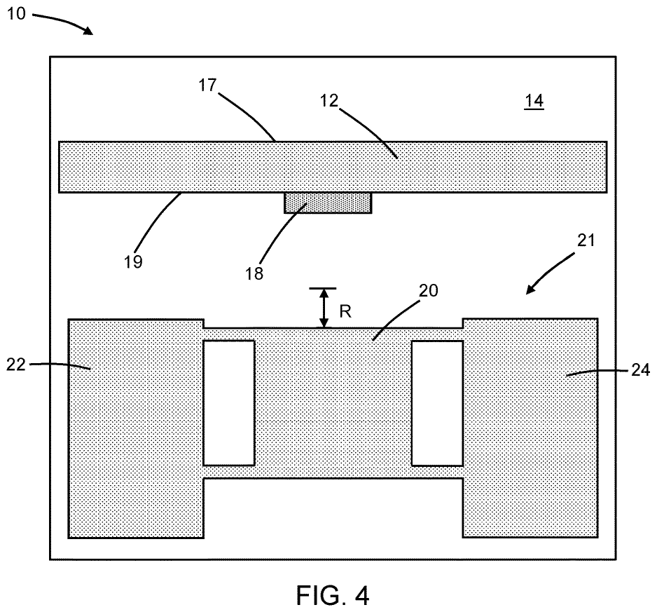

With reference to FIG. 4 and in accordance with alternative embodiments, the phase shifter embodied in the structure 10 may be configured for lateral motion of the beam 20 of the MEMS structure 21 over the travel range R in a horizontal direction responsive to an applied voltage instead of vertical motion in a vertical direction. The ferroelectric layer 18 may be arranged laterally adjacent to the section of the waveguide core 12 that is to experience the change in effective refractive index. The beam 20 of the MEMS structure 21 may be arranged laterally adjacent to the section of the waveguide core 12 with the ferroelectric layer 18 laterally between the beam 20 and the section of the waveguide core 12. In an embodiment, the ferroelectric layer 18 may adjoin the sidewall 19 of the waveguide core 12. In an embodiment, the ferroelectric layer 18 may adjoin and directly contact the sidewall 19 of the waveguide core 12.

The methods as described above are used in the fabrication of integrated circuit chips. The resulting integrated circuit chips can be distributed by the fabricator in raw wafer form (e.g., as a single wafer that has multiple unpackaged chips), as a bare die, or in a packaged form. The chip may be integrated with other chips, discrete circuit elements, and/or other signal processing devices as part of either an intermediate product or an end product. The end product can be any product that includes integrated circuit chips, such as computer products having a central processor or smartphones.

References herein to terms modified by language of approximation, such as “about”, “approximately”, and “substantially”, are not to be limited to the precise value or precise condition as specified. In embodiments, language of approximation may indicate a range of +/−10% of the stated value(s) or the stated condition(s).

References herein to terms such as “vertical”, “horizontal”, etc. are made by way of example, and not by way of limitation, to establish a frame of reference. The term “horizontal” as used herein is defined as a plane parallel to a conventional plane of a semiconductor substrate, regardless of its actual three-dimensional spatial orientation. The terms “vertical” and “normal” refer to a direction in the frame of reference perpendicular to the horizontal plane, as just defined. The term “lateral” refers to a direction in the frame of reference within the horizontal plane.

A feature “connected” or “coupled” to or with another feature may be directly connected or coupled to or with the other feature or, instead, one or more intervening features may be present. A feature may be “directly connected” or “directly coupled” to or with another feature if intervening features are absent. A feature may be “indirectly connected” or “indirectly coupled” to or with another feature if at least one intervening feature is present. A feature “on” or “contacting” another feature may be directly on or in direct contact with the other feature or, instead, one or more intervening features may be present. A feature may be “directly on” or in “direct contact” with another feature if intervening features are absent. A feature may be “indirectly on” or in “indirect contact” with another feature if at least one intervening feature is present. A feature may “overlie” another feature if the feature is positioned in elevation over another feature. Different features may “overlap” if a feature extends over, and covers all or a part of, another feature.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

1. A structure for a phase shifter, the structure comprising:
a semiconductor substrate;
a first waveguide core including a section;
a first ferroelectric layer on the section of the first waveguide core, the first ferroelectric layer comprising a ferroelectric material; and
a Micro-Electro-Mechanical Systems structure including a beam adjacent to the section of the first waveguide core and the first ferroelectric layer,
wherein the section of the first waveguide core is positioned between the first ferroelectric layer and the semiconductor substrate.

2. A structure for a phase shifter, the structure comprising:
a first waveguide core including a section;
a first ferroelectric layer on the section of the first waveguide core, the first ferroelectric layer comprising a ferroelectric material;
a Micro-Electro-Mechanical Systems structure including a beam adjacent to the section of the first waveguide core and the first ferroelectric layer; and
a power supply having a first terminal coupled to the section of the first waveguide core and a second terminal coupled to the beam of the Micro-Electro-Mechanical Systems structure.

3. The structure of claim 2 wherein the beam is configured to move relative to the first waveguide core, and the first ferroelectric layer is configured to operate with a negative capacitance when biased by the power supply.

4. The structure of claim 1 wherein the first ferroelectric layer overlaps with the section of the first waveguide core, and the beam of the Micro-Electro-Mechanical Systems structure overlies the section of the first waveguide core and the first ferroelectric layer.

5. The structure of claim 4 further comprising:
a second waveguide core including a section; and
a second ferroelectric layer on the section of the second waveguide core, the second ferroelectric layer comprising the ferroelectric material,
wherein the beam of the Micro-Electro-Mechanical Systems structure is arranged between the first waveguide core and the second waveguide core.

6. The structure of claim 1 wherein the first waveguide core has a top surface, and the first ferroelectric layer adjoins the top surface of the first waveguide core.

7. The structure of claim 6 wherein the first ferroelectric layer is in direct contact with the top surface of the first waveguide core.

8. The structure of claim 1 wherein the first waveguide core has a sidewall, and the first ferroelectric layer adjoins the sidewall of the first waveguide core.

9. The structure of claim 8 wherein the first ferroelectric layer is in direct contact with the sidewall of the first waveguide core.

10. The structure of claim 1 wherein the ferroelectric material comprises hafnium.

11. The structure of claim 1 wherein the ferroelectric material comprises hafnium and zirconium.

12. The structure of claim 1 wherein the beam comprises doped polycrystalline silicon.

13. The structure of claim 1 wherein the beam comprises a metal.

14. (canceled)

15. The structure of claim 1 further comprising:
a dielectric layer on the semiconductor substrate,
wherein the dielectric layer is positioned between the section of the first waveguide core and the semiconductor substrate.

16. The structure of claim 15 wherein the Micro-Electro-Mechanical Systems structure includes a plurality of clamping sections configured to mechanically couple the beam to the dielectric layer.

17. The structure of claim 15 wherein the Micro-Electro-Mechanical Systems structure includes a first clamping section and a second clamping section, the first clamping section and the second clamping section are mechanically coupled to the dielectric layer, and the beam is arranged between the first clamping section and the second clamping section.

18. The structure of claim 1 further comprising:
an air gap between the beam and the first waveguide core.

19. The structure of claim 18 wherein the air gap surrounds the first waveguide core and the first ferroelectric layer.

20. A method of forming a structure for a phase shifter, the method comprising:
forming a waveguide core;
forming a ferroelectric layer on a section of the waveguide core, wherein the ferroelectric layer comprises a ferroelectric material; and
forming a Micro-Electro-Mechanical Systems structure including a beam adjacent to the section of the waveguide core and the ferroelectric layer,
wherein the section of the waveguide core is positioned between the ferroelectric layer and a semiconductor substrate.

21. The structure of claim 1 further comprising:
a power supply having a first terminal coupled to the section of the first waveguide core and a second terminal coupled to the beam of the Micro-Electro-Mechanical Systems structure.
